(19) United States
(12) Patent Application Publication
(10) Pub. No.: US 2019/0121767 A1
(43) Pub. Date: Apr. 25, 2019

(54) IN-BAND RESET AND WAKE UP ON A DIFFERENTIAL AUDIO BUS

(71) Applicant: QUALCOMM Incorporated, San Diego, CA (US)

(72) Inventors: Lior Amarilio, Yokneam (IL); Amit Gil, Zichron Yaakov (IL)

(21) Appl. No.: 16/119,127

(22) Filed: Aug. 31, 2018

Related U.S. Application Data
(60) Provisional application No. 62/575,871, filed on Oct. 23, 2017.

(51) Int. Cl. G06F 13/362; G06F 3/16

(52) U.S. Cl. CPC G06F 13/3625; G06F 3/162

(57) ABSTRACT

Systems and methods for in-band reset and wake up on a differential audio bus are disclosed. In particular, after entering a low-power mode, a master device opens a drain on a transistor driving the differential audio bus. When a slave device needs the bus to wake, the slave device may transition the state of the bus. On detecting the transition of the bus, the master device may reassert control of the state of the bus and hold the bus in this new state until ready to issue a synchronization sequence. Likewise, an additional aspect of the present disclosure provides a distinctive sequence of holding the bus at a predefined state for an extended duration interrupted by a relatively brief reversal of the state that triggers a reset of all slave devices on the audio bus.

### PRIORITY CLAIM

The present application claims priority to U.S. Patent Application Ser. No. 62/575,871 filed on Oct. 23, 2017 and entitled “IN-BAND RESET AND WAKE UP ON A DIFFERENTIAL AUDIO BUS,” the contents of which is incorporated herein by reference in its entirety.

### BACKGROUND

### I. Field of the Disclosure

The technology of the disclosure relates generally to an audio bus in a computing device and, more particularly, to a SOUNDWIRE-XL/SOUNDWIRE NEXT audio bus.

### II. Background

Mobile terminals have become increasingly common in modern society. These devices have evolved from large, clunky, relatively simple telephonic devices to small, multifunction, multimedia devices with vastly improved processing power. The early mobile terminals generally provided poor sound quality and little, if any, visual image capacity. As the processing power for these mobile terminals has increased and the range of multimedia options has increased, the quality of the possible audio experience has likewise increased. In particular, contemporaneous mobile terminals may include multiple speakers and multiple microphones and, optionally, may communicate with remote audio devices such as headsets.

The MIPI® Alliance introduced the Serial Low Power Inter-chip Media Bus (SLIMbus®) protocol to help standardize communication between audio elements of a mobile terminal. While effective at providing communication between the audio elements of the mobile terminal, SLIMbus has not seen widespread acceptance by the industry. Accordingly, the MIPI Alliance has introduced the SOUNDWIRE specification to supplement and, in some cases, replace the SLIMbus protocol.

The SOUNDWIRE specification provides for a two-wire communication bus that may not exceed fifty centimeters (50 cm) in length. While such distances are readily satisfied for the audio elements within the mobile terminal, such distances may be too short for some regularly used ancillary devices such as a headset. Accordingly, the MIPI Alliance introduced a SOUNDWIRE variant allowing distances greater than 50 cm. This variant was originally referred to as SOUNDWIRE-XL and was a two-wire differential bus. Proposals within the MIPI Alliance changed SOUNDWIRE-XL from a point-to-point bus to a multi-drop bus, and the name migrated to SOUNDWIRE NEXT. Along with the change in nomenclature, the purpose of SOUNDWIRE NEXT has moved from being focused on external peripherals to inclusion within a mobile terminal. Making the SOUNDWIRE-XL bus a multi-drop bus has raised new operational issues with opportunities for new solutions.

### SUMMARY OF THE DISCLOSURE

Aspects disclosed in the detailed description include systems and methods for in-band reset and wake up on a differential audio bus. In particular, after entering a low-power mode, a master device, sometimes referred to as a downstream facing interface (DFI), opens a drain on a transistor driving the differential audio bus to cause the bus to “float” (i.e., be held at a value weakly). When a slave device, sometimes referred to as an upstream facing interface (UFI), needs the bus to wake, the slave device may transition the state of the bus, which is possible because of the weak hold on the bus. On detecting the transition of the bus, the master device may reassert control of the state of the bus and hold the bus in this new state until ready to issue a synchronization sequence. Likewise, an additional aspect of the present disclosure provides a distinctive sequence of transitions to trigger a reset of all slave devices on the bus. Thus, a mechanism is provided to allow resets in all operational conditions, including at bootup, during normal operation, during standby operations, and when a slave device is misbehaving. Likewise, in-band wake up has no requirement of a fast response time from the master device, can co-operate with the bus reset, and provides a clear indication of wake up to all devices on the bus.

In this regard in one aspect, a method for waking elements on a bus is disclosed. The method includes holding a differential audio bus at a first value while the differential audio bus is in a standby mode. The method also includes detecting a slave transitioning the differential audio bus to a second value. The method also includes holding the differential audio bus at the second value with a master of the differential audio bus after detecting the slave transitioning. The method also includes beginning a synchronization event on the differential audio bus.

In another aspect, a method for waking elements on a bus is disclosed. The method includes, while a slave device is in a standby mode, receiving an internal wake-up event for the slave device. The method also includes driving a differential audio bus from a first value to a second value. The method also includes releasing the differential audio bus. The method also includes, subsequent to releasing, receiving a synchronization event on the differential audio bus.

In another aspect, an integrated circuit (IC) is disclosed. The IC includes a bus interface configured to be coupled to a differential audio bus. The IC also includes a transceiver configured to send and receive data across the differential audio bus through the bus interface. The IC also includes a control system coupled to the transceiver. The control system is configured to hold the differential audio bus at a first value while the differential audio bus is in a standby mode. The control system is also configured to detect a slave transitioning the differential audio bus to a second value. The control system is also configured to hold the differential audio bus at the second value after detecting the slave transitioning. The control system is also configured to determine that software is ready to resume normal operation. The control system is also configured to begin a synchronization event on the differential audio bus.

In another aspect, an IC is disclosed. The IC includes a bus interface configured to couple to a differential audio bus. The IC also includes a transceiver configured to send and receive data on the differential audio bus through the bus interface. The IC also includes a control system coupled to the transceiver. The control system is configured to receive an internal wake-up event. The control system is also configured to chive the differential audio bus from a first value to a second value. The control system is also configured to release the differential audio bus. The control system is also configured to, subsequent to release, receive a synchronization event on the differential audio bus.

In another aspect, a method for resetting elements on a differential audio bus is disclosed. The method includes holding a differential audio bus at a first value until all slaves lose synchronization equal to a first time duration. The method also includes transitioning the differential audio bus to a second value for a second time duration shorter than the first time duration. The method also includes transitioning the differential audio bus to the first value for a third time duration equal to the first time duration. The method also includes beginning a synchronization event.

In another aspect, an IC is disclosed. The IC includes a bus interface configured to couple to a differential audio bus. The IC also includes a transceiver configured to send and receive data on the differential audio bus through the bus interface. The IC also includes a control system coupled to the transceiver. The control system is configured to hold the differential audio bus at a first value until all slaves lose synchronization equal to a first time duration. The control system is also configured to transition the differential audio bus to a second value for a second time duration shorter than the first time duration. The control system is also configured to transition the differential audio bus to the first value for a third time duration equal to the first time duration. The control system is also configured to begin a synchronization event.

### BRIEF DESCRIPTION OF THE FIGURES

FIG. 1 is a block diagram of an exemplary audio system including a multi-drop differential audio bus that may be used with exemplary aspects of the present disclosure;

FIG. 2 is a block diagram of a master device that may be associated with the multi-drop differential audio bus of the audio system of FIG. 1;

FIG. 3 is a block diagram of a slave device that may be associated with the multi-drop differential audio bus of the audio system of FIG. 1;

FIG. 4 is a flowchart illustrating an exemplary process for master wake up;

FIG. 5 is a flowchart illustrating an exemplary process for slave wake up;

FIG. 6 illustrates a bus state during the wake-up processes of FIGS. 4 and 5;

FIG. 7 is a flowchart illustrating an exemplary process for resetting the bus for a slave;

FIG. 8 illustrates a bus state during the bus reset process of FIG. 7;

FIG. 9A is a system-level block diagram of an exemplary mobile terminal that can include the audio system of FIG. 1;

FIG. 9B is a system-level block diagram of an alternate exemplary mobile terminal that can include the audio system of FIG. 1; and

FIG. 9C is a system-level block diagram of another alternate exemplary mobile terminal that can include the audio system of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for in-band reset and wake up on a differential audio bus. In particular, after entering a low-power mode, a master device, sometimes referred to as a downstream facing interface (DFI), opens a drain on a transistor driving the differential audio bus to cause the bus to “float” (i.e., be held at a value weakly). When a slave device, sometimes referred to as an upstream facing interface (UFI), needs the bus to wake, the slave device may transition the state of the bus, which is possible because of the weak hold on the bus. On detecting the transition of the bus, the master device may reassert control of the state of the bus and hold the bus in this new state until ready to issue a synchronization sequence. Likewise, an additional aspect of the present disclosure provides a distinctive sequence of transitions to trigger a reset of all slave devices on the bus. Thus, a mechanism is provided to allow resets in all operational conditions, including at bootup, during normal operation, during standby operations, and when a slave device is misbehaving. Likewise, in-band wake up has no requirement of a fast response time from the master device, can co-operate with the bus reset, and provides a clear indication of wake up to all devices on the bus.

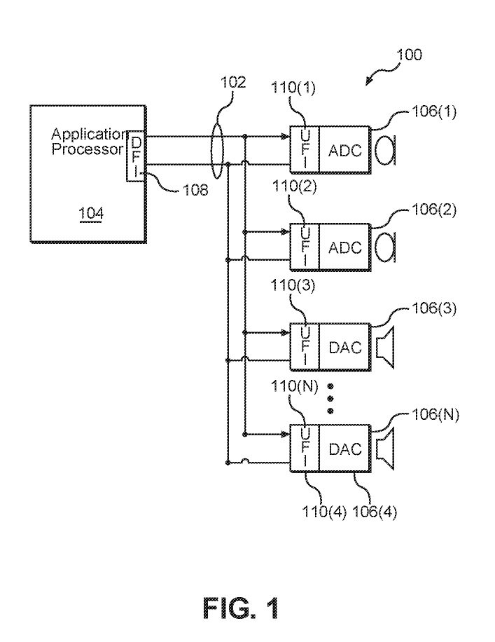

In this regard, FIG. 1 is a block diagram of an audio system 100 having a multi-drop differential audio bus 102. In particular, the bus 102 couples a master device 104 such as an audio codec or application processor to one or more slave devices 106(1)-106(N). For the purposes of illustration, N is four herein. The slave devices 106(1) and 106(2) may be microphones and include analog-to-digital converters (ADCs) while the slave devices 106(3) and 106(4) may be speakers and include digital-to-analog converters (DACs). The master device 104 includes a downstream facing interface (DFI) 108, while the slave devices 106(1)-106(N) include respective upstream facing interfaces (UFIs) 110(1)-110(N). While any multi-drop differential audio bus may use aspects of the present disclosure, exemplary aspects specifically contemplate a SOUNDWIRE NEXT multi-drop differential audio bus.

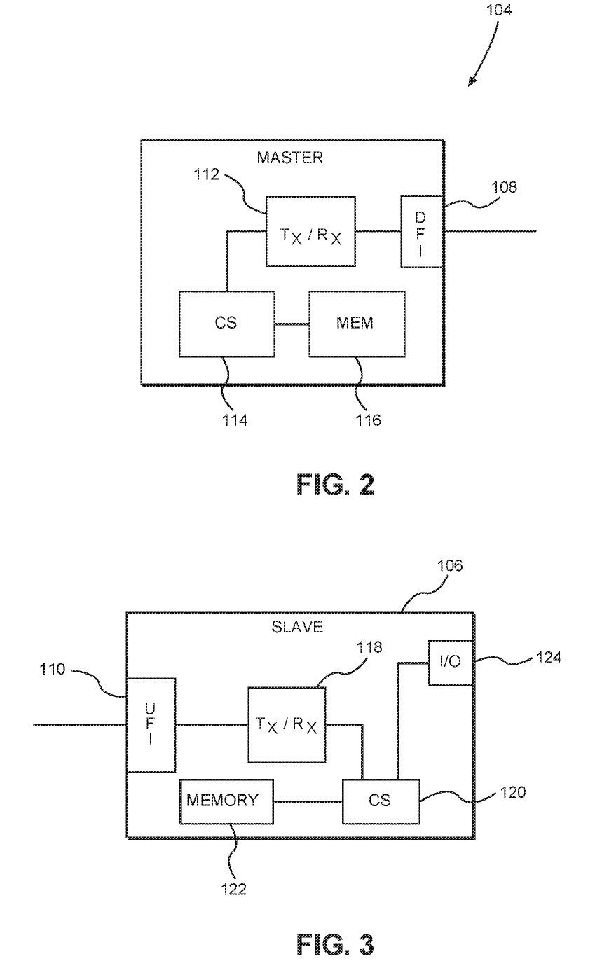

As better illustrated in FIG. 2, the master device 104 may include the DFI 108, which may be a physical layer (PHY) including one or more transistors and/or a bus keeper circuit (not illustrated) that control signal levels on the bus 102. Further, the master device 104 may include a transceiver 112 coupled to the DFI 108 and a control system (CS) 114. The control system 114 may operate software including drivers or the like and may interoperate with memory (MEM) 116. Similarly, a slave device 106 is illustrated in FIG. 3 and may include a UFI 110, which may be a PHY including one or more transistors and/or a bus keeper circuit (not illustrated) that control signal levels on the bus 102. Further, the slave device 106 may include a transceiver 118 coupled to the UFI 110 and a control system (CS) 120. The control system 120 may operate software including drivers or the like and may interoperate with a memory 122 and control an input/output device 124 (e.g., a microphone or speaker).

The benefit to SOUNDWIRE NEXT of using the wake-up and reset processes outlined herein includes the ability to perform in-band signaling, obviating the need for additional pins and conductors. Further, the processes disclosed herein are robust enough to accommodate almost any state on the bus including bootup, normal operation, standby, and misbehaving slaves. Still further, it allows operation without requiring a fast response time from the master, allows cooperation between the wake up and the bus reset, and allows a clear indication to all slaves that a wake up is taking place on the bus.

As a note of nomenclature, because the bus 102 is a differential bus, the bus 102 has two logical states: namely, the first state is where a first line carries a high voltage and a second line carries a low voltage, and the second state is where the first line carries a low voltage and the second line carries a high voltage. By definition, one of these states represents a logical one (1), and the other state represents a logical zero (0).

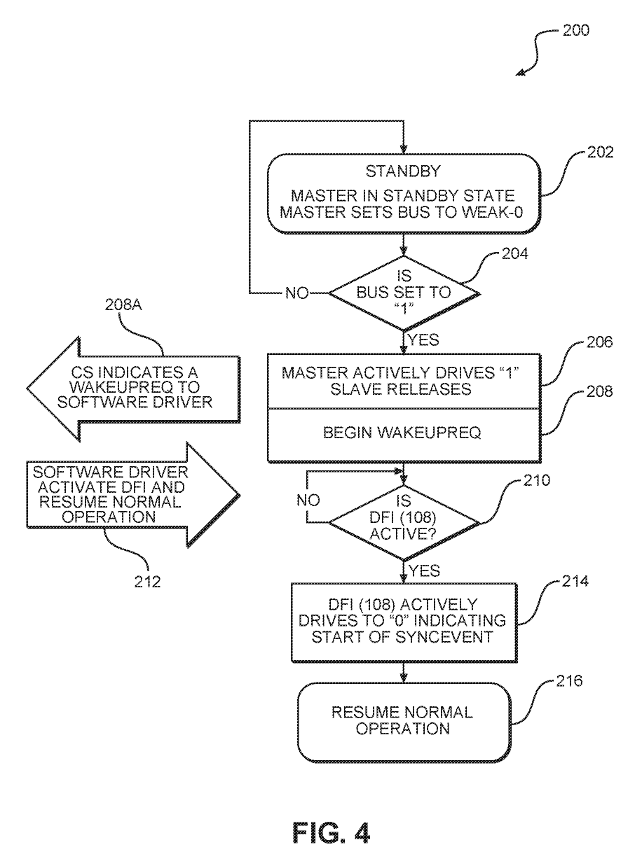

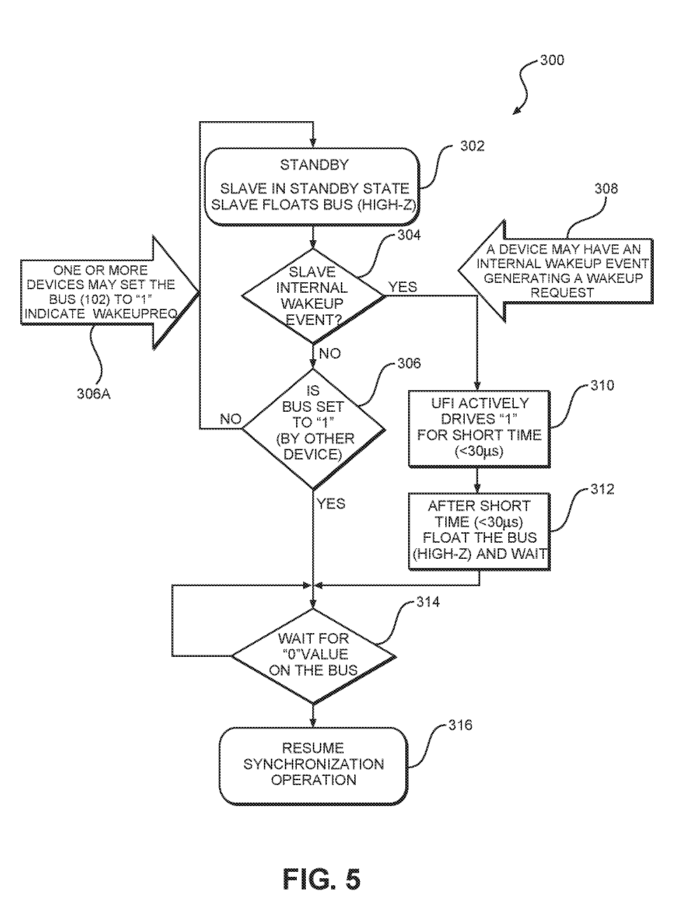

FIGS. 4 and 5 illustrate the wake-up process from the master and slave perspectives, respectively. In particular, FIG. 4 illustrates a process 200 for waking up the master device 104. Initially, the master device 104 enters a standby state, and sets the bus 102 to a weak zero (0) (block 202). The bus 102 is set to a weak zero (0) by setting one line at a high value (e.g., typically about 0.2-0.4 volts (V)) and one line is set at a low value (e.g., close to 0 V). It should be appreciated that a weak state may be maintained using weak pull-up or pull-down resistors, a bus keeper circuit, or through an open drain circuit. The master device 104 monitors to see if any entity (e.g., any of the slave devices 106(1)-106(N)) has set the bus 102 to a logical one (1) (block 204).

As long as the answer to block 204 is no, then the process 200 loops back to remain in the standby state (i.e., block 202). Once the answer to block 204 is yes, some entity has pulled the bus 102 to a logical one (1), the master device 104 actively drives a logical one (1) on the bus 102. Meanwhile, the entity that originally drove the bus 102 to logical one (1) releases the bus 102 (block 206). Concurrently, the master device 104 indicates or begins a wake-up request (wakeupReq) to the master's software driver (block 208). The wake-up request causes a command 208A to be passed up the stack to a software driver.

With continued reference to FIG. 4, the master device 104 monitors the interface to determine if the DFI 108 is active (block 210), repeating until the software driver indicates through an instruction 212 that the software driver has activated the DFI 108 (i.e., the master device 104) and resumed normal operation. Once the instruction 212 is received, the DFI 108 actively drives the bus 102 to logical zero (0) indicating the start of a synchronization event (syncevent) (block 214) and normal operation resumes (block 216).

Note that while the process 200 contemplates holding the bus 102 at a weak zero (0) to indicate the standby mode and having the slave device 106 drive the bus 102 to a logical one (1) to indicate a wake-up event, the values could equivalently be swapped without departing from the scope of the present disclosure.

On the slave side, a process 300 is illustrated in FIG. 5. The process 300 begins with the bus 102 in a standby mode and the slave device 106 in a standby state. In the standby state, the slave device 106 floats the bus 102 (e.g., by setting a high internal impedance (i.e., high z or tri-state) (block 302). The slave device 106 determines if there has been an internal wake-up event (block 304), which may have occurred. If the answer is no, there has not been an internal wake-up event at block 304, the slave device 106 determines if the bus 102 is set to a logical high (e.g., one (1)) value by some other device on the bus 102 (block 306), which may be the case if event 306A has occurred. If the answer to block 306 is no, then the process 300 returns to the standby state (block 302). An internal wake-up event is indicated by the device having an internal wake-up event that generates a wake-up request, usually through software and illustrated as event 308. Such an event 308 causes block 304 to be answered affirmatively.

With continued reference to FIG. 5, if the answer to block 304 is yes, then the UFI 110 of the slave device 106 drives the bus 102 to a logical one (1) for a short time (block 310). In an exemplary aspect, a short time is on the order of under 30 microseconds (μs). After this short time, the slave device 106 floats the bus 102 and waits (block 312). As noted above, floating the bus 102 may mean setting a high internal impedance. If the answer to block 306 is yes (i.e., some other device has requested a wake up) or after block 312, the slave device 106 waits for a logical zero (0) value on the bus 102 (block 314). When the logical zero (0) value is received, the slave device 106 resumes activity through a synchronization operation (block 316).

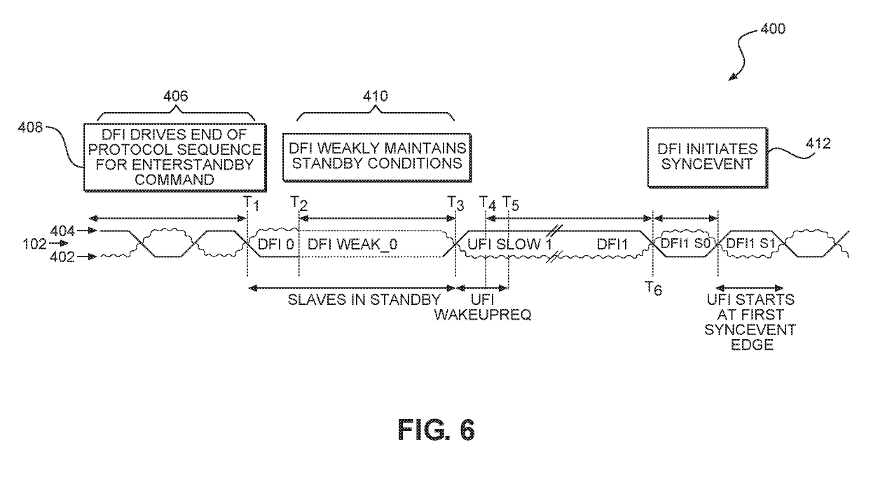

FIG. 6 illustrates the state of the bus 102 during wake up. In particular, signal flow 400 shows the two lines 402 and 404 of the bus 102. As illustrated, when line 402 carries a high voltage, the bus 102 is at a logical low (or zero (0)) and when line 404 carries a high voltage, the bus 102 is at a logical high (or one (1)). In normal operation of the bus 102, generally noted at 406, there are transitions which indicate the transfer of data between elements on the bus 102. At some point, the DFI 108 of the master device 104 drives the bus 102 in a protocol-defined sequence that corresponds to an enter standby command (block 408). After the enter standby command, the bus 102 makes one final transition at time T1 such that the DFI 108 is setting the bus 102 at a logical low (DFI 0). At some subsequent time T2, the DFI 108 of the master device 104 opens a drain on the driving transistor for the bus 102 (or uses weak pull-up or pull-down resistors) such that the bus 102 is weakly maintained at the standby condition (generally noted at 410). At some subsequent time T3, the slave device 106 has received the wake-up request (event 308, FIG. 5) and causes the bus 102 to transition to a logical high with the UFI 110 (e.g., the UFI 110 sends a wake-up request). The UFI 110 holds the bus 102 high from time T4 to time T5 to give the master device 104 time to wake and assume control (e.g., a “slow ‘1’”). Sometime after time T4, but before time T5, the master device 104 through the DFI 108 begins asserting a logical high on the bus 102 such that there will be some overlap where both the UFI 110 and the DFI 108 are holding the bus 102 high. Between time T5 and time T6, the software in the master device 104 alerts the DFI 108 that it is ready to begin normal operation (e.g., the instruction 212). Note that the time between time T5 and time T6 may be defined to be indefinite. At time T6, the master device 104 is fully awake and initiates a synchronization event (syncevent) 412 with the DFI 108. The synchronization event 412 is a particular sequence of transitions on the bus 102 according to the protocol. The slave devices 106(1)-106(N) then begin reading the bus 102 at the first synchronization event edge.

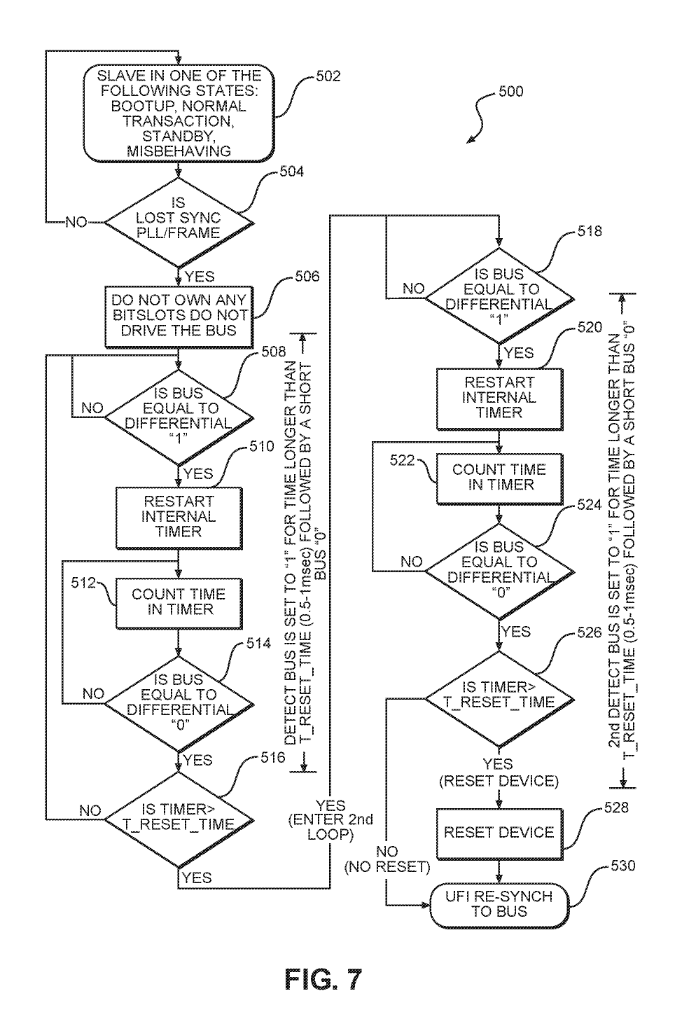

While the discussion above focuses on the wake-up process, the present disclosure is not limited to just the wake-up process. Exemplary aspects of the present disclosure also address a bus reset procedure. FIG. 7 illustrates a process 500 for bus reset. In particular, the process 500 begins with the slave device 106 starting in one of several states, including, but not limited to: bootup, normal transaction, standby, or misbehaving (block 502). The slave device 106 checks to see if the UFI 110 has lost synchronization with the frame (block 504). If the answer is no, the process 500 loops back to block 502. Once the synchronization is lost, the slave device 106 does not own any slots (bitslots) and does not drive the bus 102 (block 506).

With continued reference to FIG. 7, the slave device 106 through the UFI 110 checks to see if the bus 102 is equal to a differential logical one (1) (block 508). If the answer is no (indicating normal traffic is still happening on the bus 102), the process 500 repeats until a differential logical one (1) is detected, at which time the slave device 106 restarts an internal timer (block 510). The timer counts time (block 512) checking to see if the bus 102 is equal to a differential logical zero (0) (block 514). Once the bus 102 is set to a differential logical zero (0) by the DFI 108, the slave device 106 checks to see if the timer is greater than a predefined reset time (block 516). If the answer is no, then the bus 102 is not being reset and the process 500 loops back to block 508. In essence, blocks 508 to 516 are determining if the bus 102 is set to a differential logical one (1) for a time longer than a reset time, followed by a short differential logical zero (0) period. If the timer is greater than the reset time, then the slave device 106 through the UFI 110 checks to see if the bus 102 is equal to a differential logical one (1) (block 518) until the bus 102 is equal to a differential logical one (1), at which time the internal timer is restarted (block 520). The slave device 106 counts time with the timer (block 522) until the bus 102 is equal to a differential logical zero (0) (block 524). Once the bus 102 is at a differential logical zero (0), the slave device 106 checks to see if the timer is greater than a reset time (block 526). If the answer is yes, then the slave device 106 resets (block 528). If the answer to block 526 is no, then the slave device 106 through the UFI 110 resynchronizes with the bus 102 without resetting (block 530).

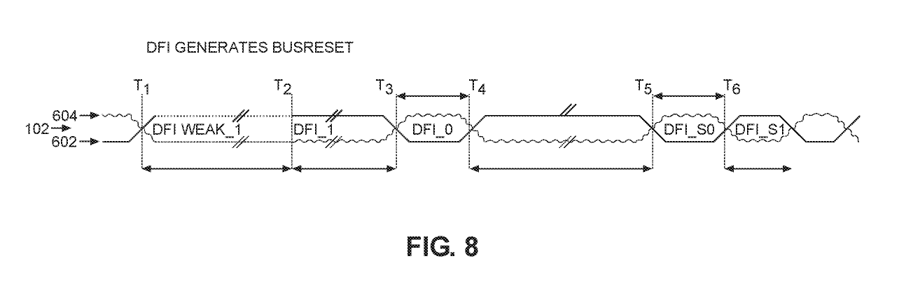

FIG. 8 shows the state of the bus 102 during a reset procedure such as the process 500. As with FIG. 6, the bus 102 has two lines 602 and 604. As illustrated, when line 602 carries a low voltage, the bus 102 is at a logical low (or zero (0)) and when line 604 carries a low voltage, the bus 102 is at a logical high (or one (1)). At time T1, the master device 104 through the DFI 108 sets the bus 102 at a weak logical high. During this time, some slave devices 106(1)-106(N) may still occasionally drive the bus 102 to a differential logical zero (0) as the slave devices 106(1)-106(N) attempt to use the bus 102. However, after sufficient time, all the slave devices 106(1)-106(N) should lose clock synchronization and will not attempt to drive the bus 102 as they do not own any bitslots. At time T2, once all slaves have lost synchronization, the master device 104 through the DFI 108 asserts a hard logical high, beginning the sequence of bus transitions that indicate the bus reset. In an exemplary aspect this may be 500-1000 μs or long enough to indicate clearly that it is a unique event and not a normal bus transition. At time T3, the master device 104 through the DFI 108 asserts a short logical low (e.g., 1 μs), followed by a long logical high at time T4 (e.g., 500-1000 μs). This sequence of two long logical highs interrupted by a short logical low is a contemplated sequence that indicates the bus reset. It is during this second long logical high that the slave devices 106(1)-106(N) reset. Other sequences could be used if accepted by the bus protocol. At time T5, the master 104 through the DFI 108 initiates a synchronization sequence, and the slaves 106(1)-106(N) start at the first synchronization event edge at time T6.

It should be appreciated that while the above discussion contemplates the standby state being associated with the weak zero (0) followed by the wake up beginning at the transition to one (1), the opposite could also be true without departing from the scope of the present disclosure. That is, standby could be a weak one (1), and the transition to zero (0) could be the beginning of the wake up.

The systems and methods for in-band reset and wake up on a differential audio bus according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

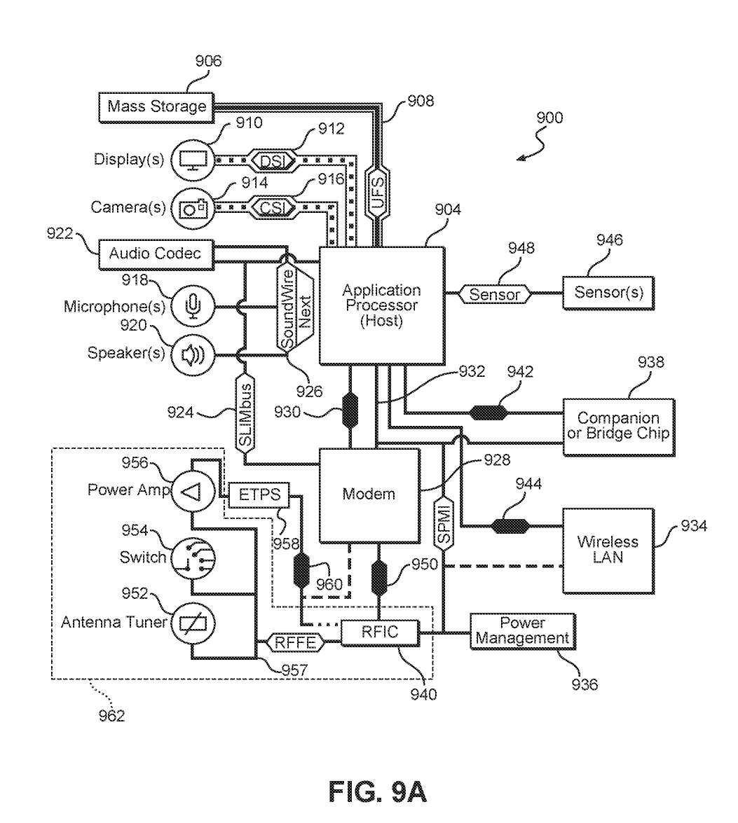

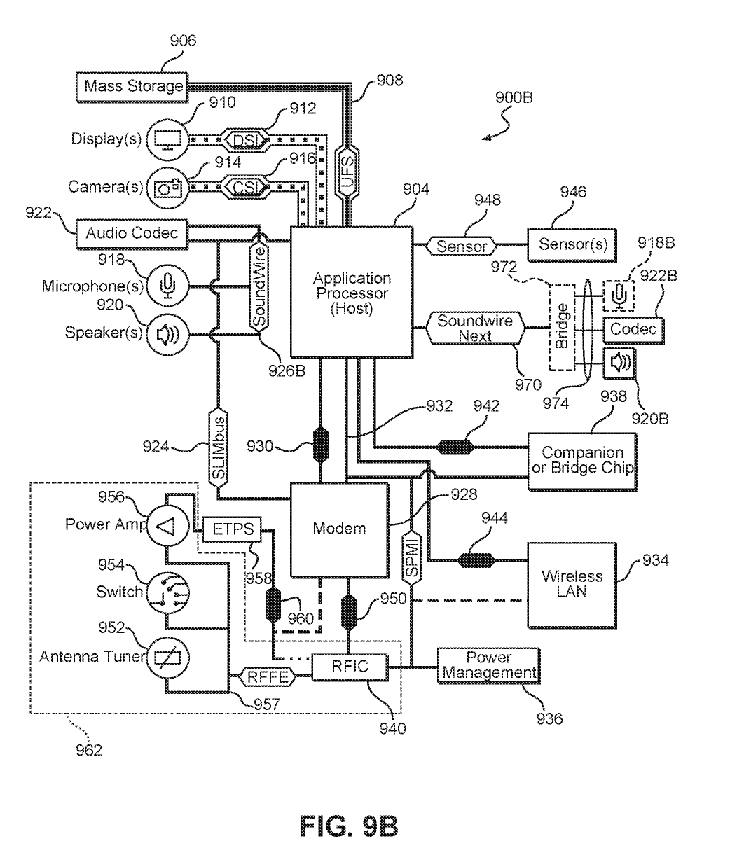

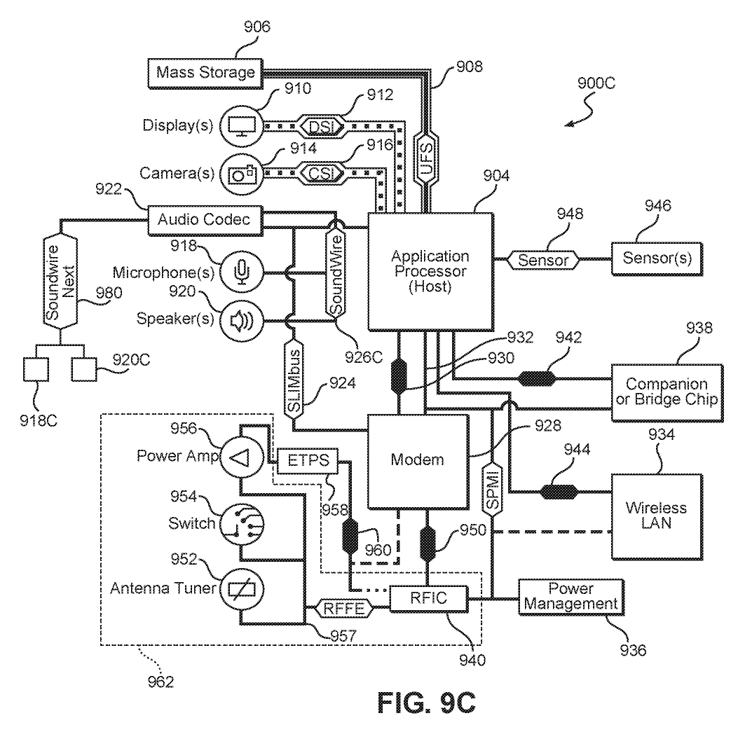

Exemplary aspects of the present disclosure are well suited for use with a SOUNDWIRE NEXT bus. There are a variety of locations in a computing device at which a SOUNDWIRE NEXT bus may be placed. In this regard, FIGS. 9A-9C illustrate various placements. In most instances, the overall architecture is the same. In this regard, FIG. 9A is system-level block diagram of an exemplary mobile terminal 900 such as a smart phone, mobile computing device tablet, or the like. While a mobile terminal is particularly contemplated as being capable of benefiting from exemplary aspects of the present disclosure, it should be appreciated that the present disclosure is not so limited and may be useful in any system having a multi-drop differential bus without satisfactory wake-up and bus reset processes. For the sake of illustration, it is assumed that a SOUNDWIRE NEXT bus 926, which may be the bus 102, within the mobile terminal 900 is among multiple communication buses configured to use the in-band reset and wake-up processes on a differential audio bus according to the present disclosure.

With continued reference to FIG. 9A, the mobile terminal 900 includes an application processor 904 (sometimes referred to as a host) that communicates with a mass storage element 906 through a universal flash storage (UFS) bus 908. The application processor 904 may further be connected to a display 910 through a display serial interface (DSI) bus 912 and a camera 914 through a camera serial interface (CSI) bus 916. Various audio elements such as a microphone 918, a speaker 920, and an audio codec 922 may be coupled to the application processor 904 through a serial low power interchip multimedia bus (SLIMbus) 924. Additionally, the audio elements may communicate with each other and the codec 922 through the SOUNDWIRE NEXT bus 926. A modem 928 may also be coupled to the SLIMbus 924. The modem 928 may further be connected to the application processor 904 through a peripheral component interconnect (PCI) or PCI express (PCIe) bus 930 and/or a system power management interface (SPMI) bus 932. Note that the SLIMbus 924 may be replaced by a SOUNDWIRE bus in some implementations.

With continued reference to FIG. 9A, the SPMI bus 932 may also be coupled to a wireless local area network (WLAN) integrated circuit (IC) (WLAN IC) 934, a power management integrated circuit (PMIC) 936, a companion integrated circuit (sometimes referred to as a bridge chip) 938, and a radio frequency integrated circuit (RFIC) 940. It should be appreciated that separate PCI buses 942 and 944 may also couple the application processor 904 to the companion integrated circuit 938 and the WLAN IC 934. The application processor 904 may further be connected to sensors 946 through a sensor bus 948. The modem 928 and the RFIC 940 may communicate using a bus 950.

With continued reference to FIG. 9A, the RFIC 940 may couple to one or more radio frequency front end (RFFE) elements, such as an antenna tuner 952, a switch 954, and a power amplifier 956 through an RFFE bus 957. Additionally, the RFIC 940 may couple to an envelope tracking power supply (ETPS) 958 through a bus 960, and the ETPS 958 may communicate with the power amplifier 956.

FIG. 9B illustrates an alternate placement of the SOUNDWIRE NEXT bus. While the majority of the elements are the same as the mobile terminal 900, the mobile terminal 900B illustrated in FIG. 9B has a SOUNDWIRE bus 926B coupling the audio codec 922 to the microphone(s) 918 and the speaker(s) 920. The application processor 904 may be coupled to a SOUNDWIRE NEXT bus 970 that may couple to an optional bridge 972. If the bridge 972 is present, then the bus 974 may be a SOUNDWIRE bus. If the bridge 972 is not present, then the SOUNDWIRE NEXT bus 970 may couple directly to microphones 918B, speakers 920B, and/or an audio codec 922B.

Similarly, FIG. 9C illustrates another alternate placement of the SOUNDWIRE NEXT bus. In the mobile terminal 900C, the audio codec 922 may couple to a SOUNDWIRE bus 926C and a SOUNDWIRE NEXT bus 980. The SOUNDWIRE NEXT bus 980 may couple to microphones 918C and speakers 920C.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A method for waking elements on a bus, the method comprising:
holding a differential audio bus at a first value while the differential audio bus is in a standby mode;
detecting a slave transitioning the differential audio bus to a second value;
after detecting the slave transitioning, holding the differential audio bus at the second value with a master of the differential audio bus; and
beginning a synchronization event on the differential audio bus.

2. The method of claim 1, further comprising initially driving the differential audio bus to the first value with the master of the differential audio bus.

3. The method of claim 1, further comprising determining that the master is ready to resume normal operation before beginning the synchronization event.

4. The method of claim 2, wherein driving the differential audio bus comprises driving a SOUNDWIRE NEXT or SOUNDWIRE-XL audio bus.

5. The method of claim 1, wherein the first value is one and the second value is zero.

6. The method of claim 1, wherein the first value is zero and the second value is one.

7. The method of claim 1, further comprising activating software to wake components in the master after detecting the slave transitioning.

8. A method for waking elements on a bus, the method comprising:
while a slave device is in a standby mode, receiving an internal wake-up event for the slave device;
driving a differential audio bus from a first value to a second value;
releasing the differential audio bus; and
subsequent to releasing, receiving a synchronization event on the differential audio bus.

9. The method of claim 8, further comprising associating the slave device with the differential audio bus.

10. The method of claim 8, further comprising entering the standby mode associated with the differential audio bus.

11. The method of claim 8, wherein driving the differential audio bus comprises driving a SOUNDWIRE NEXT or SOUNDWIRE-XL audio bus.

12. The method of claim 8, wherein the first value is one and the second value is zero.

13. The method of claim 8, wherein the first value is zero and the second value is one.

14. The method of claim 8, further comprising waiting for the synchronization event from a master.

15. The method of claim 8, further comprising concurrently keeping the differential audio bus at the second value with a master of the differential audio bus prior to releasing.

16. The method of claim 8, further comprising resuming operation at a first edge of the synchronization event.

17. An integrated circuit (IC) comprising:
a bus interface configured to be coupled to a differential audio bus;
a transceiver configured to send and receive data across the differential audio bus through the bus interface; and
a control system coupled to the transceiver and configured to:
hold the differential audio bus at a first value while the differential audio bus is in a standby mode;
detect a slave transitioning the differential audio bus to a second value;
after detecting the slave transitioning, hold the differential audio bus at the second value;
determine that software is ready to resume normal operation; and
begin a synchronization event on the differential audio bus.

18. The IC of claim 17, wherein the IC is selected from a group consisting of an application processor, a codec, and a bridge.

19. The IC of claim 17, wherein the bus interface is configured to couple SOUNDWIRE NEXT or SOUNDWIRE-XL audio bus.

20. The IC of claim 17, wherein the control system is further configured to drive the differential audio bus to the first value.

21. The IC of claim 17, wherein the control system is further configured to determine that the software is ready to resume normal operation before beginning the synchronization event.

22. The IC of claim 17, wherein the control system is configured to hold the differential audio bus at the second value concurrently with the slave.

23. The IC of claim 17 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

24. An integrated circuit (IC) comprising:
a bus interface configured to couple to a differential audio bus;
a transceiver configured to send and receive data on the differential audio bus through the bus interface; and
a control system coupled to the transceiver and configured to:
receive an internal wake-up event;
drive the differential audio bus from a first value to a second value;
release the differential audio bus; and
subsequent to release, receive a synchronization event on the differential audio bus.

25. The IC of claim 24, wherein the control system is further configured to associate the IC with the differential audio bus.

26. The IC of claim 24, wherein the control system is further configured to enter a standby mode associated with the differential audio bus.

27. The IC of claim 24, wherein the bus interface comprises a SOUNDWIRE NEXT or SOUNDWIRE-XL audio bus interface.

28. The IC of claim 24, wherein the control system is further configured to wait for the synchronization event from a master.

29. A method for resetting elements on a differential audio bus, comprising:
holding a differential audio bus at a first value until all slaves lose synchronization equal to a first time duration;
transitioning the differential audio bus to a second value for a second time duration shorter than the first time duration;
transitioning the differential audio bus to the first value for a third time duration equal to the first time duration; and
beginning a synchronization event.

30. An integrated circuit (IC) comprising:
a bus interface configured to couple to a differential audio bus;
a transceiver configured to send and receive data on the differential audio bus through the bus interface; and
a control system coupled to the transceiver and configured to:
hold the differential audio bus at a first value until all slaves lose synchronization equal to a first time duration;
transition the differential audio bus to a second value for a second time duration shorter than the first time duration;
transition the differential audio bus to the first value for a third time duration equal to the first time duration; and
begin a synchronization event.
